(19) United States
(12) Patent Application Publication
(10) Pub. No.: US 2014/0306077 A1
(43) Pub. Date: Oct. 16, 2014

(54) Holiday Light Looper

(71) Applicants: Kelly Patricia O'Meara, Alexandria, VA (US); James David Haskins, San Antonio, TX (US)

(72) Inventors: Kelly Patricia O'Meara, Alexandria, VA (US); James David Haskins, San Antonio, TX (US)

(21) Appl. No.: 13/999,485

(22) Filed: Mar. 4, 2014

Related U.S. Application Data
(60) Provisional application No. 61/853,847, filed on Apr. 15, 2013.

(51) Int. Cl. E06C 7/14; F16M 13/02

(52) U.S. Cl. CPC E06C 7/14; F16M 13/02
USPC 248/211

(57) ABSTRACT

The “Holiday Light Looper” is intended for utility in the holiday ornamental string light market. There currently are no apparatus available for hands-free hanging and storage of ornamental string lights. The reverse fish hook design of the Holiday Light Looper allows the string lights to be draped around the lower loop for easy, tangle-free hanging, while the upper reverse loop is used to hang the string lights from a ladder, gutter, trouser belt loop and for storage. The total design, as seen in (FIG. 1.), allows both hands to be available for attaching the string lights to the house, tree or bushes.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BRIEF SUMMARY OF INVENTION

The Holiday Light Looper is a device created to allow easy, hands-free, hanging and storage/removal of ornamental holiday string lights, by stringing lights around lower portion of “Looper.”

### BACKGROUND OF INVENTION

The ornamental “Holiday Light Looper” was invented in order to facilitate easy electric ornamental string light hanging. For example, one of the problems with current methods of hanging electric ornamental string lights is that both hands are not free to actually hang the lights.

One hand usually is being used to hold the string or ball of lights, which normally are tangled and unruly. This same problem arises when taking electric ornamental lights down from the house or tree(s). The Holiday Light Looper allows the person hanging the electric ornamental lights to have the use of both hands and keeps the lights from tangling during the hanging and removal process.

### DETAILED DESCRIPTION

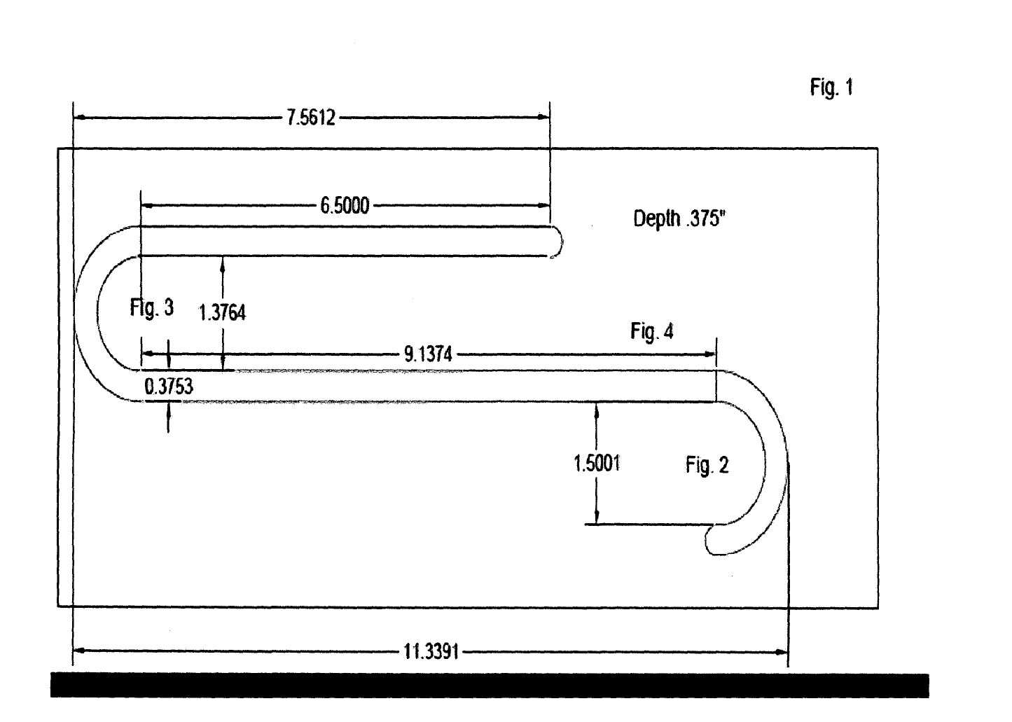

This invention (Holiday Light Looper) is a reverse fish-hook type handle that can be hung from a ladder rung, home gutters or even a trouser belt loop, with up to 200 electric ornamental lights looped around the lower end of the hook (FIG. 1.), making for quick, tangle-free and easy hanging and removing of string electric ornamental lights.

The Light Looper is made of strong Casting Resin (2390 psi Tensile Strength) (7990 psi Compression Strength) not susceptible to extreme variations in cold or hot weather. The Light Looper is a single, solid plastic, unit that can easily be handled as strings of electric ornamental lights are hung and removed from house, Christmas tree (in-door or outside) or lawn bushes and trees.

This invention is for anyone who hangs electric ornamental lights inside the house or on the exterior of the home. While there are other methods of hanging ornamental lights, the Light Looper allows for hands-free hanging insomuch as the “Looper” hangs from either a ladder, gutter or even trouser belt loops (FIG. 5) and allows the person to have both hands free to attached the string to the house or tree.

This is a very simple and inexpensive method for hanging and taking down ornamental lights. The lights are simply looped back onto the “Looper” when it is time to take them down. The Light Looper is a tangle-free method of hanging, removing and storing string electric ornamental lights.

This is an innovative simple design solution for easy hanging, removing and storing ornamental string lights. It is a safer way to hang ornamental lights as it frees up both hands, rather than one hand being used to hold the bunch of string lights that may, for example, be wound on a reel or piece of wood.

### DRAWING

### One Drawing

FIG. 1 encompasses entire drawing of Light Looper. There is a reverse curved top “hook portion.” (FIG. 2) for hanging, a straight extended portion—approximately 12 inches (FIG. 4) and a curved bottom light string support portion—extending upward approximately 6 inches (FIG. 3). Each of these portions make up one solid piece, measuring approximately one foot (top of reverse hook to bottom hook).
This is a device for facilitating the hanging of a string of ornamental electrical lights on a house, tree or the like, said device comprising: a first top reverse hooked portion shaped to engage a rung of a ladder, said first hooked portion having a distal end that extends a distance at least as long as the thickness of the rung, a light string support portion shaped to support a string of electric ornamental lights, said light string support portion (lower hook) having a U-shape, and an extendable portion connecting said first top hooked portion to said light string support portion (upper hook).

1. The top smaller portion of the Light Looper hangs from any ladder, home roof gutter or even trouser belt loop.

2. The top smaller portion of the Light Looper can be hung on just about anything and easily fits on any standard closet bar or garage hook for convenient storage.

3. The Light Looper makes easy the hanging of electric ornamental lights because its design allows the person hanging the lights to have both hands free.

4. The Light Looper can be used in-doors or outside.

5. The lower portion of the Light Looper will easily carry a 200-foot string of mini holiday lights and 100 feet of standard ornamental bulbs. Although the description of the present invention contains specifics of the preferred embodiment and use, these should not be construed as limiting the scope of the invention. The Embodiment described herein is subject to variation in structure, design, and manufacturing methodology.
